(19) United States
(12) Patent Application Publication
(10) Pub. No.: US 2022/0153002 A1
(43) Pub. Date: May 19, 2022

(54) Breathable Barrier Laminate

(71) Applicant: Berry Global, Inc., Evansville, IN (US)

(72) Inventors: Yongji Jin, Suzhou (CN); Junying Gao, Suzhou (CN); Minglan Fang, Suzhou (CN)

(21) Appl. No.: 17/525,064

(22) Filed: Nov. 12, 2021

(30) Foreign Application Priority Data
Nov. 13, 2020 (CN) 202011268918.6

(51) Int. Cl. B32B 27/12; B32B 5/02; B32B 27/20; B32B 37/18; B32B 38/00

(52) U.S. Cl. CPC B32B 27/12; B32B 5/022; B32B 27/20; B32B 37/182; B32B 2038/0028; B32B 2307/724; B32B 2307/7265; B32B 2437/00; B32B 38/0012

(57) ABSTRACT

A barrier laminate suitable for use in the construction of chemically protective garments is provided. The barrier laminate includes a nonwoven layer bonded to a breathable microporous film layer. Methods of forming a barrier laminate are also provided.

### CROSS-REFERENCE TO RELATED APPLICATIONS

This application claims priority under 35 U.S.C. § 119 to Chinese Patent Application No. 202011268918.6 filed Nov. 13, 2020, which is expressly incorporated by reference herein in its entirety.

### TECHNICAL FIELD

Embodiments of the presently-disclosed invention relate generally to barrier laminates that prevent penetration of various liquids while simultaneously allow moisture vapor to pass through the barrier laminates. The barrier laminates include a nonwoven layer bonded to a breathable microporous film, which includes a plurality of pores formed therein. Embodiments of the presently-disclosed invention also relate to methods of forming such barrier laminates, protective garments, and method of forming protective garments.

### BACKGROUND

A variety of industries have a continued need for various types of limited-use or disposable protective garments designed to provide liquid barrier properties. Protective garments, such as coveralls, can be used to effectively seal off a wearer from a harmful environment in ways that open or cloak style garments (for example, drapes, gowns and the like) are unable to do. Accordingly, coveralls have many applications where isolation of a wearer is desirable. Drapes and gowns, however, may also provide suitable protection for applications in which complete isolation of a wearer is not required. Regardless, protective clothing can maintain the cleanliness of clothing worn underneath the protective clothing as well as protect the wearers skin from exposure to undesirable materials (e.g., liquid chemicals). For instance, prevention of hazardous liquids passing through the protective garments is of particular importance. Workers, however, may wear such protective garments for extended periods of time and/or in working conditions associated with an elevated temperature. As such, the protective garments would ideally be comfortable to a wearer while providing the necessary level of barrier properties.

Therefore, there remains a desire in the art for breathable barrier laminates and protective clothing formed from such barrier laminates, which prevent or mitigate penetration by liquids while also maintaining a desirable level of breathability.

### SUMMARY

One or more embodiments of the invention may address one or more of the aforementioned problems. In accordance with certain embodiments, the invention provides a barrier laminate, such as a liquid chemical barrier laminate, that includes a nonwoven layer and a breathable microporous film layer attached to the nonwoven layer. In accordance with certain embodiments of the invention, the breathable microporous film layer includes a plurality of pores having an average pore diameter from about 0.01 to about 5 microns, such as at least about any of the following: 0.01, 0.015, 0.02, 0.025, 0.03, 0.035, 0.04, 0.045, 0.05, 0.06, 0.07, 0.08, 0.09, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1, 1.2, 1.4, and 1.5 microns, and/or at most about any of the following: 5, 4.8, 4.6, 4.4, 4.2, 4, 3.8, 3.6, 3.4, 3.2, 3, 2.8, 2.6, 2.4, 2.2, 2, 1.8, 1.6, and 1.5 microns. In accordance with certain embodiments of the invention, the breathable microporous film layer includes a plurality of pores having an average pore diameter, for example, from about 0.01 to about 0.5 microns, such as at least about any of the following: 0.01, 0.015, 0.02, 0.025, 0.03, 0.035, 0.04, 0.045, 0.05, 0.06, 0.07, 0.08, 0.09, and 0.1, microns, and/or at most about any of the following: 0.50, 0.45, 0.40, 0.35, 0.30, 0.25, 0.20 and 0.15 microns.

In another aspect the present invention provides a protective garment including one or more barrier laminates as described and disclosed herein. For instance, the protective garment may comprise a pair of coveralls, a jacket, sleeves, a jump-suit, a pair of pants, a foot covering, a boot covering, a glove, a hood, or an apron. In accordance with certain embodiments of the invention, the protective garment provides a Type 3 or Type 4 level of chemical protection per EN14605, or Type 5 level of chemical protection per EN13982-1, or Type 6 level of chemical protection per EN13034, wherein the protective garment is breathable.

In another aspect, the present invention provides a method of forming a barrier laminate. The method may comprise the following: providing or forming a nonwoven layer; providing or forming a breathable microporous film layer; and bonding the nonwoven layer to the breathable microporous film layer. The breathable microporous film, in accordance with certain embodiments of the invention, includes a plurality of pores having an average pore diameter from about 0.01 to about 5 microns, such as at least about any of the following: 0.01, 0.015, 0.02, 0.025, 0.03, 0.035, 0.04, 0.045, 0.05, 0.06, 0.07, 0.08, 0.09, 0.1, 0.2, 0.3, 0.4, 0.5, 0.6, 0.7, 0.8, 0.9, 1, 1.2, 1.4, and 1.5 microns, and/or at most about any of the following: 5, 4.8, 4.6, 4.4, 4.2, 4, 3.8, 3.6, 3.4, 3.2, 3, 2.8, 2.6, 2.4, 2.2, 2, 18, 1.6, and 1.5 microns.

In yet another aspect, the present invention provides a method of forming a protective garment, in which the method may include the following: providing or forming a first barrier laminate component; providing or forming a second barrier laminate component, wherein the first barrier laminate component is the same or different than the second barrier component; and bonding a first portion of the first barrier laminate component to a second portion of the second barrier component.

### BRIEF DESCRIPTION OF THE DRAWING(S)

The invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout, and wherein:

FIG. 1 illustrates a cross-sectional view of a barrier laminate in accordance with certain embodiments of the invention; and

FIG. 2 illustrates a protective garment in accordance with certain embodiments of the invention.

### DETAILED DESCRIPTION

The invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. As used in the specification, and in the appended claims, the singular forms “a”, “an”, “the”, include plural referents unless the context clearly dictates otherwise.

The presently-disclosed invention relates generally to a barrier laminate, which may be liquid-proof and suitable for use in protective clothing against liquid chemicals per the EN 14605 standard. In accordance with certain embodiments of the invention, the barrier laminate and/or protective garments formed, at least in part, from barrier laminates as described and disclosed herein may be, for example, classified as Type 4 per the EN standard. The barrier laminates described and disclosed herein include a desirable level of breathability while simultaneously providing a liquid-proof material (e.g., prevent and/or mitigate penetration by various liquids). The enhanced breathability realized by barrier laminates and protective garments, in accordance with certain embodiments of the invention, provide or impart an enhanced level of comfort to a user (e.g., an individual wearing a protective garment formed from barrier laminates as described and disclosed herein). For instance, the barrier laminates may be referred to as breathable articled that provide protection against penetration by liquid chemicals per, for example, Type 4 requirement. In accordance with certain embodiments of the invention, the barrier laminate may comprise a bi-layer laminate of a nonwoven layer and a breathable microporous film layer. The breathable microporous film layer, for example, may include a plurality of micron-sized and/or sub-micron-sized pores. The plurality of micron-sized and/or sub-micron-sized pores of the breathable microporous film may be formed by including a plurality of filler particles within a polymeric melt material used to form the film followed by a stretching operation (e.g., incrementally stretching the film in a cross-direction and/or a machine direction). In accordance with certain embodiments of the invention, the stretching operation may be controlled to ensure that the resulting average pore size and/or distribution of the pores sizes is within a few microns or even at the scale of sub-microns as described and disclosed herein. In accordance with certain embodiments of the invention, the breathable microporous film layer may include one or two skin layers (e.g., the breathable microporous film layer may be sandwiched between two thinner film layers that function as outer skin layers to the breathable microporous film layer). In accordance with certain embodiments of the invention, the breathable microporous film layer is devoid of any skin layers adjacent thereto.

The terms “substantial” or “substantially” may encompass the whole amount as specified, according to certain embodiments of the invention, or largely but not the whole amount specified (e.g., 95%, 96%, 97%, 98%, or 99% of the whole amount specified) according to other embodiments of the invention.

The terms “polymer” or “polymeric”, as used interchangeably herein, may comprise homopolymers, copolymers, such as, for example, block, graft, random, and alternating copolymers, terpolymers, etc., and blends and modifications thereof. Furthermore, unless otherwise specifically limited, the term “polymer” or “polymeric” shall include all possible structural isomers; stereoisomers including, without limitation, geometric isomers, optical isomers or enantionmers; and/or any chiral molecular configuration of such polymer or polymeric material. These configurations include, but are not limited to, isotactic, syndiotactic, and atactic configurations of such polymer or polymeric material. The term “polymer” or “polymeric” shall also include polymers made from various catalyst systems including, without limitation, the Ziegler-Natta catalyst system and the metallocene/single-site catalyst system. The term “polymer” or “polymeric” shall also include, in according to certain embodiments of the invention, polymers produced by fermentation process or biosourced.

The terms “nonwoven”, and “nonwoven web”, as used herein, may comprise a web having a structure of individual fibers, filaments, and/or threads that are interlaid but not in an identifiable repeating manner as in a knitted or woven fabric. Nonwoven fabrics or webs, according to certain embodiments of the invention, may be formed by any process conventionally known in the art such as, for example, meltblowing processes, spunbonding processes, needle-punching, hydroentangling, air-laid, and bonded carded web processes. A “nonwoven web”, as used herein, may comprise a plurality of individual fibers that have not been subjected to a consolidating process.

The term “nonwoven layer”, as used herein, may comprise a web of fibers in which a plurality of the fibers are mechanically entangled or interconnected, fused together, and/or chemically bonded together. For example, a nonwoven web of individually laid fibers may be subjected to a bonding or consolidation process to mechanically entangle, or otherwise bond, at least a portion of the individually fibers together to form a coherent (e.g., united) web of interconnected fibers.

The term “consolidated” and “consolidation”, as used herein, may comprise the bringing together of at least a portion of the fibers of a nonwoven web into closer proximity or attachment there-between (e.g., thermally fused together, chemically bonded together, and/or mechanically entangled together) to form a bonding site, or bonding sites, which function to increase the resistance to external forces (e.g., abrasion and tensile forces), as compared to the unconsolidated web. The bonding site or bonding sites, for example, may comprise a discrete or localized region of the web material that has been softened or melted and optionally subsequently or simultaneously compressed to form a discrete or localized deformation in the web material. Furthermore, the term “consolidated” may comprise an entire nonwoven web that has been processed such that at least a portion of the fibers are brought into closer proximity or attachment there-between (e.g., thermally fused together, chemically bonded together, and/or mechanically entangled together), such as by thermal bonding or mechanical entanglement (e.g., hydroentanglement) as merely a few examples.

The term “staple fiber”, as used herein, may comprise a cut fiber from a filament. In accordance with certain embodiments, any type of filament material may be used to form staple fibers. For example, staple fibers may be formed from polymeric fibers, and/or elastomeric fibers. Non-limiting examples of materials may comprise polyolefins (e.g., a polypropylene or polypropylene-containing copolymer), polyethylene terephthalate, and polyamides. The average length of staple fibers may comprise, by way of example only, from about 2 centimeter to about 15 centimeter.

The term “layer”, as used herein, may comprise a generally recognizable combination of similar material types and/or functions existing in the X-Y plane.

The term “multi-component fibers”, as used herein, may comprise fibers formed from at least two different polymeric materials or compositions (e.g., two or more) extruded from separate extruders but spun together to form one fiber. The term “bi-component fibers”, as used herein, may comprise fibers formed from two different polymeric materials or compositions extruded from separate extruders but spun together to form one fiber. The polymeric materials or polymers are arranged in a substantially constant position in distinct zones across the cross-section of the multi-component fibers and extend continuously along the length of the multi-component fibers. The configuration of such a multi-component fiber may be, for example, a sheath/core arrangement wherein one polymer is surrounded by another, an eccentric sheath/core arrangement, a side-by-side arrangement, a pie arrangement, or an “islands-in-the-sea” arrangement, each as is known in the art of multicomponent, including bicomponent, fibers.

The term “machine direction” or “MD”, as used herein, comprises the direction in which the fabric produced or conveyed. The term “cross-direction” or “CD”, as used herein, comprises the direction of the fabric substantially perpendicular to the MD.

As used herein, the term “continuous fibers” refers to fibers which are not cut from their original length prior to being formed into a nonwoven web or nonwoven fabric. Continuous fibers may have average lengths ranging from greater than about 15 centimeters to more than one meter, and up to the length of the web or fabric being formed. For example, a continuous fiber, as used herein, may comprise a fiber in which the length of the fiber is at least 1,000 times larger than the average diameter of the fiber, such as the length of the fiber being at least about 5,000, 10,000, 50,000, or 100,000 times larger than the average diameter of the fiber.

As used herein, the term “aspect ratio”, comprise a ratio of the length of the major axis to the length of the minor axis of the cross-section of the fiber in question.

The term “spunbond”, as used herein, may comprise fibers which are formed by extruding molten thermoplastic material as filaments from a plurality of fine, usually circular, capillaries of a spinneret with the diameter of the extruded filaments then being rapidly reduced. According to an embodiment of the invention, spunbond fibers are generally not tacky when they are deposited onto a collecting surface and may be generally continuous as disclosed and described herein. It is noted that the spunbond used in certain composites of the invention may include a nonwoven described in the literature as SPINLACE®.

The term “meltblown”, as used herein, may comprise fibers formed by extruding a molten thermoplastic material through a plurality of fine die capillaries as molten threads or filaments into converging high velocity, usually hot, gas (e.g. air) streams which attenuate the filaments of molten thermoplastic material to reduce their diameter, which may be to microfiber diameter, according to certain embodiments of the invention. According to an embodiment of the invention, the die capillaries may be circular. Thereafter, the meltblown fibers are carried by the high velocity gas stream and are deposited on a collecting surface to form a web of randomly disbursed meltblown fibers. Meltblown fibers may comprise microfibers which may be continuous or discontinuous and are generally tacky when deposited onto a collecting surface. Meltblown fibers, however, are shorter in length than those of spunbond fibers.

The term “filler”, as used herein, may comprise particles or aggregates of particles and other forms of materials that can be added to a polymeric film blend. According to certain embodiments of the invention, a filler will not substantially chemically interfere with or adversely affect the extruded film. According to certain embodiments of the invention, the filler is capable of being uniformly dispersed throughout the film or a layer comprised in a multilayer film. Fillers may comprise particulate inorganic materials such as, for example, calcium carbonate, various kinds of clay, alumina, barium sulfate, sodium carbonate, magnesium sulfate, titanium dioxide, zeolites, aluminum sulfate, cellulose-type powders, magnesium sulfate, magnesium carbonate, barium carbonate, kaolin, mica, carbon, calcium oxide, magnesium oxide, aluminum hydroxide, glass particles, and the like, and organic particulate materials such as high-melting point polymers (e.g., TEFLON® and KEVLAR® from E.I. DuPont de Nemours and Company), pulp powder, wood powder, cellulose derivatives, chitin and chitin derivatives, and the like. Filler particles may optionally be coated with a fatty acid, such as stearic acid or reduced stearic acid, or a larger chain fatty acid, such as behenic acid. Without intending to be bound by theory, coated filler particles may facilitate the free flow of the particles (in bulk) and their ease of dispersion into the polymer matrix, according to certain embodiments of the invention.

All whole number end points disclosed herein that can create a smaller range within a given range disclosed herein are within the scope of certain embodiments of the invention. By way of example, a disclosure of from about 10 to about 15 includes the disclosure of intermediate ranges, for example, of: from about 10 to about 11; from about 10 to about 12; from about 13 to about 15; from about 14 to about 15; etc. Moreover, all single decimal (e.g., numbers reported to the nearest tenth) end points that can create a smaller range within a given range disclosed herein are within the scope of certain embodiments of the invention. By way of example, a disclosure of from about 1.5 to about 2.0 includes the disclosure of intermediate ranges, for example, of: from about 1.5 to about 1.6; from about 1.5 to about 1.7; from about 1.7 to about 1.8; etc.

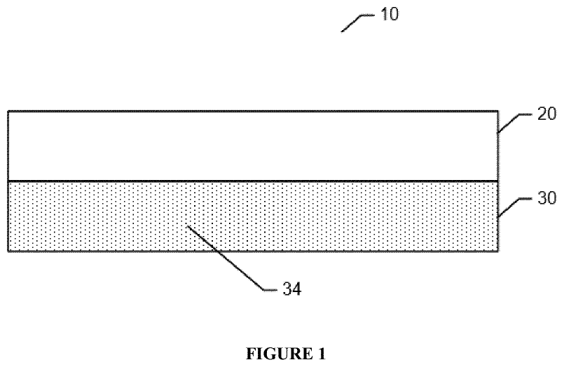

In one aspect, the invention provides a barrier laminate, such as a liquid chemical barrier laminate, that includes a nonwoven layer and a breathable microporous film layer attached to the nonwoven layer. In accordance with certain embodiments of the invention, the breathable microporous film layer includes a plurality of pores having an average pore diameter from about 0.01 to about 5 microns, such as at least about any of the following: 0.01, 0.015, 0.02, 0.025, 0.03, 0.035, 0.04, 0.045, 0.05, 0.06, 0.07, 0.08, 0.09, 0.1, 0.2, 0.3, 0.4, 0.5, 0.6, 0.7, 0.8, 0.9, 1, 1.2, 1.4, and 1.5 microns, and/or at most about any of the following: 5, 4.8, 4.6, 4.4, 4.2, 4, 3.8, 3.6, 3.4, 3.2, 3, 2.8, 2.6, 2.4, 2.2, 2, 18, 1.6, and 1.5 microns. In accordance with certain embodiments of the invention, the breathable microporous film layer includes a plurality of pores having an average pore diameter, for example, from about 0.01 to about 0.5 microns, such as at least about any of the following: 0.01, 0.015, 0.02, 0.025, 0.03, 0.035, 0.04, 0.045, 0.05, 0.06, 0.07, 0.08, 0.09, and 0.1, microns, and/or at most about any of the following: 0.50, 0.45, 0.40, 0.35, 0.30, 0.25, 0.20 and 0.15 microns. FIG. 1, for instance shows a barrier laminate 10 including a nonwoven layer 20 bonded to a breathable microporous film layer 30, in which the breathable microporous film layer includes a plurality of pores 34.

In accordance with certain embodiments of the invention, the barrier laminate may have a basis weight from about 10 to about 300 grams-per-square-meter (gsm), such as at least about any of the following: 10, 12, 15, 18, 20, 22, 25, 28, 30, 32, 35, 38, 40, 42, 45, 48, 50, 55, and 60 gsm, and/or at most about any of the following: 300, 250, 200, 150, 125, 100, 95, 90, 85, 80, 75, 70, 65, 60, 55, and 50 gsm.

In accordance with certain embodiments of the invention, about 90% to about 100%, such as from about 92%, 94%, 95%, 96%, 98%, or 99%, of the plurality of pores has an individual pore diameter (e.g., the largest diameter for an individual pore) from at most about 0.5 microns (e.g., from at most about 1 micron) from the average pore diameter, such as at most about any of the following: 1, 0.9, 0.8, 0.7, 0.6, 0.5, 0.4, 0.3, 0.2, 0.1 microns from the average pore diameter, and/or at least about any of the following: 0.01, 0.02, 0.04, 0.05, 0.06, 0.08, and 0.1 microns from the average pore diameter. By way of example only, the average pore diameter may comprise about 1 micron, while at least 95% of the plurality of pores have a diameter within 0.4 microns of the average pore diameter. Stated somewhat differently, at least about 95% of the individual pores may have a diameter within the range of 0.6 microns to 1.4 microns. In accordance with certain embodiments of the invention, the plurality of pores has a pore-size-distribution comprising a standard deviation (SD) from about 0.01 microns to about 1 micron, such as at least about any of the following: 0.01, 0.025, 0.05, 0.075, 0.1, 0.125, 0.15, 0.175, 0.20, 0.225, 0.25, 0.275, 0.3, 0.35, 0.4, 0.45, and 0.5 microns, and/or at most about any of the following: 1, 0.9, 0.8, 0.7, 0.6, and 0.5 microns; wherein the SD is calculated from a sample population including at least about 50 individual pores, such as at least about 75, 100, 150, 200, 250, 300, 350, 400, 450, 500, 750, or 1000 individual pores. By way of example only, the average pore diameter may comprise about 0.09 microns and the SD of the pore-size-distribution may be about 0.05 microns. In accordance with certain embodiments of the invention, the average pore diameter and/or the pore-size-distribution may be controlled by the choice of filler particles, diameters of the filler particles (e.g., average diameter and/or distribution of sizes), stretching conditions (e.g., degree of stretching, temperature at which stretching occurs, rate at which stretching occurs, etc.), or any combinations thereof.

In accordance with certain embodiments of the invention, the breathable microporous film layer may further comprise a plurality of filler particles. The plurality of filler particles may have an diameter from about 0.1 to about 6 microns, such as at least about any of the following: 0.1, 0.2, 0.3, 0.4, 0.5, 0.6, 0.7, 0.8, 0.9, 1, 1.2, 1.4, and 1.5 microns, and/or at most about any of the following: 6, 5.5, 5, 4.8, 4.6, 4.4, 4.2, 4, 3.8, 3.6, 3.4, 3.2, 3, 2.8, 2.6, 2.4, 2.2, 2, 18, 1.6, and 1.5 microns. The plurality of filler particles may have a filler-particle-size-distribution comprising a standard deviation (SD) from about 0.01 microns to about 1 micron, such as at least about any of the following: 0.01, 0.025, 0.05, 0.075, 0.1, 0.125, 0.15, 0.175, 0.20, 0.225, 0.25, 0.275, 0.3, 0.35, 0.4, 0.45, and 0.5 microns, and/or at most about any of the following: 1, 0.9, 0.8, 0.7, 0.6, and 0.5 microns; wherein the SD is calculated from a sample population including at least about 50 individual filler particles, such as at least about 75, 100, 150, 200, 250, 300, 350, 400, 450, or 500 individual filler particles.

In accordance with certain embodiments of the invention, the plurality of filler particles may comprise an inorganic filler, an organic filler, a polymeric filler, or any combination thereof. For instance, the plurality of filler particles may comprise individual particles or aggregates of particles and other forms of materials that can be added to a polymeric film blend. Fillers may comprise particulate inorganic materials such as, for example, calcium carbonate, various kinds of clay, alumina, barium sulfate, sodium carbonate, magnesium sulfate, titanium dioxide, zeolites, aluminum sulfate, cellulose-type powders, magnesium sulfate, magnesium carbonate, barium carbonate, kaolin, mica, carbon, calcium oxide, magnesium oxide, aluminum hydroxide, glass particles, and the like, and organic particulate materials such as high-melting point polymers (e.g., TEFLON® and KEVLAR® from E.I. DuPont de Nemours and Company), pulp powder, wood powder, cellulose derivatives, chitin and chitin derivatives, and the like. Filler particles may optionally be coated with a fatty acid, such as stearic acid or reduced stearic acid, or a larger chain fatty acid, such as behenic acid. Without intending to be bound by theory, coated filler particles may facilitate the free flow of the particles (in bulk) and their ease of dispersion into the polymer matrix, according to certain embodiments of the invention.

The barrier laminate, in accordance with certain embodiments of the invention, comprises at least one nonwoven layer. The nonwoven layer, for example, may comprise a spunbond layer, a meltblown layer, a carded layer of staple fibers, a sub-micron fiber containing layer, or any combination thereof. For example, the nonwoven layer may comprise a spunbond-meltblown-spunbond structure, in which the number is spunbond layers and meltblown layers may vary independently from each other.

The barrier laminate, in accordance with certain embodiments of the invention, may comprise a structure according to one of the following:

S1ₐ-M1_{b}-S2_{c}; and (Structure 1)

S1ₐ-M1_{b}-S3_{d}-M2_{c}-S2_{c}; (Structure 2)

wherein,
‘M1’ comprises a first meltblown layer or a first group of multiple meltblown layers;
‘M2’ comprises a second meltblown layer or a second group of multiple meltblown layers;
‘S1’ comprises a first spunbond layer or a first group of multiple spunbond layers;
‘S2’ comprises a second spunbond layer or a second group of multiple spunbond layers;
‘S3’ comprises a third spunbond layer or a third group of multiple spunbond layers;
‘a’ represents the number of layers and is independently selected from 0, 1, 2, 3, 4, 5, 6, 7, 8, 9, and 10;
‘b’ represents the number of layers and is independently selected from 0, 1, 2, 3, 4, 5, 6, 7, 8, 9, and 10;
‘c’ represents the number of layers and is independently selected from 0, 1, 2, 3, 4, 5, 6, 7, 8, 9, and 10;
‘d’ represents the number of layers and is independently selected from 0, 1, 2, 3, 4, 5, 6, 7, 8, 9, and 10; and
‘e’ represents the number of layers and is independently selected from 0, 1, 2, 3, 4, 5, 6, 7, 8, 9, and 10;
wherein for Structure 1 the sum of ‘a’, ‘b’, and ‘c’ is not zero (e.g., ‘a’, ‘b’, and ‘c’ are not zero at the same time); and
wherein for Structure 2 the sum of ‘a’, ‘b’, ‘c’, ‘d’, and ‘e’ is not zero (e.g., ‘a’, ‘b’, ‘c’, ‘d’, and ‘e’ are not zero at the same time).

In accordance with certain embodiments of the invention, the nonwoven layer comprises a structure according to one of the following:

S1ₐ-N1_{y}-S2_{c}; (Structure 3)

S1ₐ-M1_{b}-N1_{y}-S2_{c}; (Structure 4)

S1ₐ-N1_{y}-S3_{d}-N2_{z}-S2_{c}; (Structure 5)

S1ₐ-N1_{y}-M1_{b}-N2_{z}-S2_{c}; (Structure 6)

S1ₐ-M1_{b}-S3_{d}-M2_{c}-S2_{c}; (Structure 7)

S1ₐ-M1_{b}-N1_{y}-M2_{c}-S2_{c}; (Structure 8)

wherein
‘M1’ comprises a first meltblown layer or a first group of multiple meltblown layers;
‘M2’ comprises a second meltblown layer or a second group of multiple meltblown layers;
‘N1’ comprises a first sub-micron fiber-containing layer or a first group of multiple sub-micron fiber-containing layers;
‘N2’ comprises a second sub-micron fiber-containing layer or a second group of multiple sub-micron fiber-containing layers;
‘Si’ comprises a first spunbond layer or a first group of multiple spunbond layers;
‘S2’ comprises a second spunbond layer or a second group of multiple spunbond layers;
‘S3’ comprises a third spunbond layer or a third group of multiple spunbond layers;
‘a’ represents the number of layers and is independently selected from 0, 1, 2, 3, 4, 5, 6, 7, 8, 9, and 10;
‘b’ represents the number of layers is independently selected from 0, 1, 2, 3, 4, 5, 6, 7, 8, 9, and 10;
‘c’ represents the number of layers is independently selected from 0, 1, 2, 3, 4, 5, 6, 7, 8, 9, and 10;
‘d’ represents the number of layers is independently selected from 0, 1, 2, 3, 4, 5, 6, 7, 8, 9, and 10;
‘e’ represents the number of layers is independently selected from 0, 1, 2, 3, 4, 5, 6, 7, 8, 9, and 10;
‘y’ represents the number of layers is independently selected from 0, 1, 2, 3, 4, and 51, 2, 3, 4, 5, 6, 7, 8, 9, and 10; and
‘z’ represents the number of layers is independently selected from 0, 1, 2, 3, 4, 5, 6, 7, 8, 9, and 10;
wherein for Structure 3 the sum of ‘a’, ‘y’, and ‘c’ is not zero (e.g., ‘a’, ‘y’, and ‘c’ are not zero at the same time);
wherein for Structure 4 the sum of ‘a’, ‘b’, ‘y’, and ‘c’ is not zero (e.g., ‘a’, ‘b’, ‘y’, and ‘c’ are not zero at the same time);
wherein for Structure 5 the sum of ‘a’, ‘y’, ‘d’, ‘z’, and ‘c’ is not zero (e.g., ‘a’, y, ‘ d’, ‘z’, and ‘c’ are not zero at the same time);
wherein for Structure 6 the sum of ‘a’, ‘y’, ‘b’, ‘z’, and ‘c’ is not zero (e.g., ‘a’, ‘y’, ‘b’, ‘z’, and ‘c’ are not zero at the same time);
wherein for Structure 7 the sum of ‘a’, ‘b’, ‘d’, ‘e’, and ‘c’ is not zero (e.g., ‘a’, ‘b’, ‘d’, ‘e’, and ‘c’ are not zero at the same time); and
wherein for Structure 8 the sum of ‘a’, ‘b’, ‘y’, ‘e’, and ‘c’ is not zero (e.g., ‘a’, ‘b’, ‘y’, ‘e’, and ‘c’ are not zero at the same time).

In accordance with certain embodiments of the invention, the nonwoven layer may comprise a synthetic polymeric material, a biopolymer, or any combination thereof. For example, the synthetic polymeric material may comprise a polyolefin, a polyamide, a polyester, or any combination thereof. By way of example only, the polymeric material may comprise a high density polypropylene or a high density polyethylene, a low density polypropylene or a low density polyethylene, a linear low density polypropylene or a linear low density polyethylene, a copolymer of polypropylene or ethylene, and any combination thereof. In certain embodiments of the invention, for instance, the polymeric material may comprise polypropylene of one or more different forms, such as a homopolymer, a random copolymer, a polypropylene made with a Ziegler-Natta or metallocene or other catalyst system. The polypropylene may be provided in a variety of configurations including isotactic, syndiotactic, and atactic configurations of polypropylene. In accordance with certain embodiments of the invention, the polymeric material may comprise a biopolymer (e.g., polylactic acid (PLA), polyhydroxyalkanoates (PHA), and poly(hydroxycarboxylic) acids). For example, the fibers of the nonwoven layer may comprise a blend of two or more biopolymers. In accordance with certain embodiments, the nonwoven layer and/or one or more of the fibers forming the nonwoven layer may comprise a blend or mixture of one or more biopolymers and optionally one or more synthetic polymer (e.g. a polyolefin). In accordance with certain embodiments of the invention, the nonwoven layer and/or one or more of the fibers forming the nonwoven layer may comprise from about 30 to 100% by weight of the biopolymer, such as at most about any of the following: 100, 90, 80, 70, 60, and 50% by weight of the biopolymer and/or at least about any of the following: 30, 40, 50, and 60% by weight of the biopolymer.

In accordance with certain embodiments of the invention, the nonwoven layer may be untreated or treated with one or more additives, such as a liquid repellent (e.g., a hydrophobic surfactant and/or a binder material) and/or an antistatic finish.

The fibers forming the nonwoven layer may independently comprise a variety of cross-sectional geometries and/or deniers, such as round or non-round cross-sectional geometries. In accordance with certain embodiments of the invention, the nonwoven layer may comprise a plurality of first fibers that may comprise all or substantially all of the same cross-sectional geometry or a mixture of differing cross-sectional geometries to tune or control various physical properties. In this regard, the first plurality of fibers may comprise a round cross-section, a non-round cross-section, or combinations thereof. In accordance with certain embodiments of the invention, for example, the first plurality of fibers may comprise from about 10% to about 100% of round cross-sectional fibers, such as at most about any of the following: 100, 95, 90, 85, 75, and 50% and/or at least about any of the following: 10, 20, 25, 35, 50, and 75%. Additionally or alternatively, the first plurality of fibers may comprise from about 10% to about 100% of non-round cross-sectional fibers, such as at most about any of the following: 100, 95, 90, 85, 75, and 50% and/or at least about any of the following: 10, 20, 25, 35, 50, and 75%. In accordance with embodiments of the invention including non-round cross-sectional fibers, these non-round cross-sectional fibers may comprise an aspect ratio of greater than 1.5:1, such as at most about any of the following: 10:1, 9:1, 8:1, 7:1, 6:1, 5:1, 4:1, 3:1, and 2:1 and/or at least about any of the following: 1.5:1, 2:1, 2.5:1, 3:1, 4:1, 5:1, and 6:1. In accordance with certain embodiments of the invention, the aspect ratio, as used herein, may comprise a ratio of the length of the major axis to the length of the minor axis of the cross-section of the fiber in question.

In accordance with certain embodiments of the invention, the first plurality of fibers may comprise mono-component fiber, multi-component fibers, or any combination thereof. Multi-component fibers may have a sheath/core configuration, a side-by-side configuration, a pie configuration, an islands-in-the-sea configuration, a multi-lobed configuration, or any combinations thereof. In accordance with certain embodiments of the invention, the sheath/core configuration may comprise an eccentric sheath/core configuration (e.g., bi-component fiber) including a sheath component and core component that is not concentrically located within the sheath component. The core component, for example, may define at least a portion of an outer surface of the fiber having the eccentric sheath/core configuration in accordance with certain embodiments of the invention. In accordance with certain embodiments of the invention, the first plurality of fibers may comprise continuous spunbond fibers forming an outer portion or surface of the nonwoven layer with optionally one or more layers of meltblown and/or sub-micron fibers adjacent or proximate to the first plurality of fibers (e.g., Structure 1-7 above).

In accordance with certain embodiments of the invention, the nonwoven layer may have a basis weight from about 10 to about 300 grams-per-square-meter (gsm), such as at least about any of the following: 10, 12, 15, 18, 20, 22, 25, 28, 30, 32, 35, 38, 40, 42, 45, 48, and 50 gsm, and/or at most about any of the following: 300, 250, 200, 150, 100, 95, 90, 85, 80, 75, 70, 65, 60, 55, and 50 gsm.

In accordance with certain embodiments of the invention, the breathable microporous film layer comprises a synthetic polymeric material, such as a polyolefin, a polyamide, a polyester, a biopolymer, or any combination thereof. For example, the synthetic polymeric material may comprise a polypropylene, a polyethylene, a copolymer including propylene monomers, a copolymer including ethylene monomers, a copolymer including propylene and ethylene monomers, or any combination thereof.

The breathable microporous film layer, in accordance with certain embodiments of the invention, may have a basis weight from about 5 to about 80 gsm, such as at least about any of the following: 5, 8, 10, 12, 15, 18, 20, 25, 30, 35, 40, and 45 gsm, and/or at most about any of the following: 80, 75, 70, 65, 60, 55, 50, and 45 gsm. The breathable microporous film layer may have a thickness in a z-direction that is perpendicular to a cross-direction and a machine-direction, the thickness ranges from about 10 to about 2500 microns, such as at least about any of the following: 10, 25, 50, 75, 100, 150, 200, 250, 300, 350, 400, 450, 500, 550, 600, 650, 700, 750, 800, 850, 900, 950, 1000, 1200, and 1500 microns, and/or at most about 2500, 2200, 2000, 1800, 1600, and 1500 microns.

In accordance with certain embodiment of the invention, the plurality of filler particles may comprise from about 1 to about 60 wt. % of the breathable microporous film layer, such as at least about any of the following: 1, 3, 5, 8, 10, 12, 15, 18, 20, 22, and 25 wt. % of the breathable microporous film layer, and/or at most about any of the following: 60, 55, 50, 45, 40, 38, 35, 32, 30, 28, and 25 wt. % of the breathable microporous film layer. In accordance with certain embodiments of the invention, for example, the plurality of filler particles may comprise from about 10 to about 60 wt. % of the breathable microporous film layer.

In accordance with certain embodiment of the invention, the nonwoven layer may be directly (e.g., thermally bonded directly together) and/or indirectly (e.g., adhesively bonded together) attached (e.g., bonded) to the breathable microporous film layer. For example, the barrier laminate further comprises an adhesive layer located between the breathable microporous film layer and the nonwoven layer. The adhesive layer, for example, may comprise a discontinuous coating to mitigate against inhibiting moisture vapor transmission through the barrier laminate. The adhesive layer, in accordance with certain embodiments of the invention, may comprise a discontinuous pattern of an adhesive composition, in which the adhesive composition of the discontinuous pattern covers from about 2% to about 40% of a first surface of the breathable microporous film layer, such as at least about any of the following: 2, 3, 5, 8, 10, 12, 15, 18, 20, and 22% of the first surface, and/or at most about any of the following: 40, 38, 35, 32, 30, 28, 25, 24, and 22% of the first surface. By way of example only, the discontinuous pattern may comprises a plurality of dots, a plurality of hollow circular shapes, a plurality of straight lines, a plurality of non-linear lines, or any combinations thereof. In accordance with certain embodiments of the invention, the discontinuous pattern comprises a grid formation defining a plurality of islands that are devoid of the adhesive composition.

In accordance with certain embodiment of the invention, a precursor film to the breathable microporous film layer may be extrusion coated onto the nonwoven layer to form a precursor laminate. In this regard, the precursor laminate may be stretched to impart the plurality of pores in the precursor film to form the breathable microporous film layer. In this regard, the breathable microporous film layer is directly bonded to the nonwoven layer.

In accordance with certain embodiment of the invention, the breathable microporous film layer is thermally bonded to the nonwoven layer. The barrier laminate, for example, may include a pattern of thermal bond sites, wherein the breathable microporous film layer is thermally bonded to the nonwoven layer at the thermal bond sites. The pattern of thermal bond sites, for example, may define a bonded area from about 2% to about 40% of the barrier laminate, such as at least about any of the following: 2, 3, 5, 8, 10, 12, 15, 18, 20, and 22% of the barrier laminate, and/or at most about any of the following: 40, 38, 35, 32, 30, 28, 25, 24, and 22% of the barrier laminate.

In accordance with certain embodiments of the invention, the barrier laminate may be provided in the form or as part of a protective garment (e.g., liquid chemical protective garment). For example, the protective garment may comprise, for example, a pair of coveralls, a jacket, a jump-suit, a pair of pants, a foot covering, a glove, a hood, or an apron. In accordance with certain embodiments of the invention, the barrier laminate and/or the protective garment provides a Type 3 or Type 4 level of chemical protection per EN14605, or a Type 5 level of protection per EN13982-1, or a Type 6 level of chemical protection per EN13034.

In accordance with certain embodiments of the invention, the barrier laminate and/or the protective garment meets class 6 classification in accordance with ISO6529:2013 (Protective clothing—Protection against chemicals—Determination of resistance of protective clothing materials to permeation by liquids and gases).

In accordance with certain embodiments of the invention, the barrier laminate and/or the protective garment meets class 6 classification in accordance with ISO 11603:2004 (Determination of resistance of protective clothing materials to permeation by blood and bodily fluids).

In accordance with certain embodiments of the invention, the barrier laminate and/or the protective garment meets class 6 classification in accordance with ISO11604:2004 (Determination of resistance of protective clothing materials to permeation by blood-borne pathogens).

In accordance with certain embodiments of the invention, the barrier laminate has a moisture vapor transmission rate (MVTR) of about 500 to about 3500 g/24 hrs/m² as determined by ASTM Test Method E-96D, such as at least about any of the following: 500, 600, 700, 800, 900, 1000, 1200, 1500 g/24 hrs/m², and/or at most about any of the following: 3500, 3000, 2500, 2200, 2000, 1800, 1500, and 1200 g/24 hrs/m².

In accordance with certain embodiments of the invention, the nonwoven layer, the breathable microporous film layer, and/or the barrier laminate has a percent elongation at break from about 5% to about 150% in the machine direction and/or the cross-direction as per the standard test method ASTM D5034, such as at least about any of the following: 5, 10, 15, 20, 25, 30, 35, 40, 45, 50, 60, 70, 70, 90, and 100% in the machine direction and/or the cross-direction as per the standard test method ASTM D5034, and/or at most about any of the following: 150, 140, 130, 120, 110, and 100% in the machine direction and/or the cross-direction as per the standard test method ASTM D5034.

In another aspect, the present invention provides a method of forming a barrier laminate, such as those described and disclosed herein. The method may comprise the following: providing or forming a nonwoven layer such as those described and disclosed herein; providing or forming a breathable microporous film layer such as those described and disclosed herein; and bonding the nonwoven layer to the breathable microporous film layer such as by any means described and disclosed herein. The breathable microporous film, in accordance with certain embodiments of the invention, includes a plurality of pores having an average pore diameter from about 0.01 to about 5 microns, such as at least about any of the following: 0.01, 0.015, 0.02, 0.025, 0.03, 0.035, 0.04, 0.045, 0.05, 0.06, 0.07, 0.08, 0.09, 0.1, 0.2, 0.3, 0.4, 0.5, 0.6, 0.7, 0.8, 0.9, 1, 1.2, 1.4, and 1.5 microns, and/or at most about any of the following: 5, 4.8, 4.6, 4.4, 4.2, 4, 3.8, 3.6, 3.4, 3.2, 3, 2.8, 2.6, 2.4, 2.2, 2, 18, 1.6, and 1.5 microns.

In accordance with certain embodiments of the invention, the method of forming a barrier laminate may comprise bonding the nonwoven layer to a pre-microporous film (e.g., a precursor film to the breathable microporous film) to form a precursor laminate, and forming the plurality of pores via incrementally stretching the precursor laminate to form the barrier laminate. Alternatively, bonding the nonwoven layer to the breathable microporous film layer comprises thermally bonding the nonwoven layer to the breathable microporous film layer, adhesively bonding the nonwoven layer to the breathable microporous film layer, or a combination thereof. In this regard, a breathable microporous film layer may be bonded to the nonwoven layer after formation of the plurality of pores or the pre-microporous film (e.g., a precursor film to the breathable microporous film) may be bonded to the nonwoven layer to form a precursor laminate, followed by stretching (e.g., incrementally stretching) the precursor laminate to form the plurality of pores.

In accordance with certain embodiments of the invention, the method of forming a barrier laminate may comprise extrusion coating a pre-microporous film onto the nonwoven layer to form a precursor laminate, and forming the plurality of pores via stretching (e.g., incrementally stretching) the precursor laminate to form the barrier laminate.

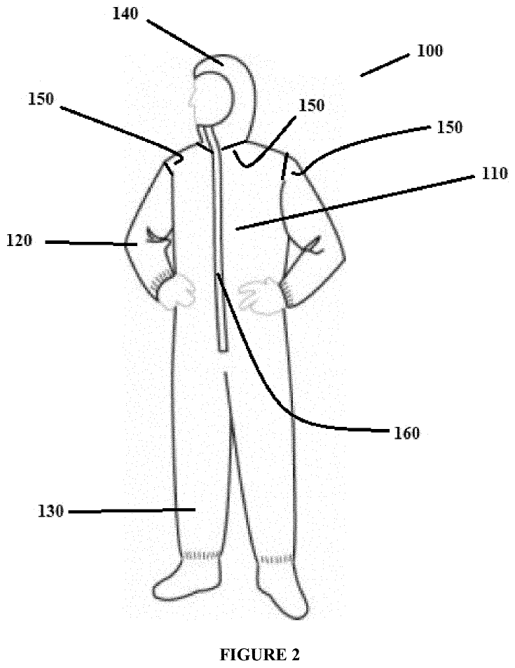

In another aspect the present invention provides a protective garment including one or more barrier laminates as described and disclosed herein. For instance, the protective garment may comprise a pair of coveralls, a jacket, sleeves, a jump-suit, a pair of pants, a foot covering, a boot covering, a glove, a hood, or an apron. In accordance with certain embodiments of the invention, the protective garment a Type 3 or Type 4 level of chemical protection per EN14605, or a Type 5 level of chemical protection per EN13982-1, or a Type 6 level of chemical protection per EN13034. FIG. 2, for example, illustrates a protective garment 100 including a body portion 110, sleeves 120, leg portions 130 and a hood portion 140. The protective garment 100 of FIG. 2 also illustrates a plurality of seams 150 (e.g., thermal seams) formed between two separate barrier laminate components. The protective garment 100 shown in FIG. 2 also includes a closure feature 160 (e.g., zipper, Velcro-closure, etc.). In accordance with certain embodiments of the invention, a sleeve 120 may be formed from a single barrier laminate component that has been bonded to itself to form the sleeve structure via a thermal seam extending along the length of the sleeve, while one end of the sleeve may be thermally bonded to a second barrier laminate component and/or a third barrier laminate component forming all or part of the body portion 110 of the protective garment via a thermally formed seal (e.g., seal 150 in FIG. 2)

In yet another aspect, the present invention provides a method of forming a protective garment, in which the method may include the following: providing or forming a first barrier laminate component; providing or forming a second barrier laminate component, wherein the first barrier laminate component is the same or different than the second barrier component; and bonding a first portion of the first barrier laminate component to a second portion of the second barrier component. In accordance with certain embodiments of the invention, the step of bonding the first portion of the first barrier laminate component to the second portion of the second barrier component comprises thermally bonding the first portion to the second portion to form a thermally bonded seam joining the first portion to the second portion. One or more barrier laminate components may be cut, folded, bonded, or otherwise configured to form a protective garment, such as a pair of coveralls, a jacket, sleeves, a jump-suit, a pair of pants, a foot covering, a boot covering, a glove, a hood, or an apron.

These and other modifications and variations to the invention may be practiced by those of ordinary skill in the art without departing from the spirit and scope of the invention, which is more particularly set forth in the appended claims. In addition, it should be understood that aspects of the various embodiments may be interchanged in whole or in part. Furthermore, those of ordinary skill in the art will appreciate that the foregoing description is by way of example only, and it is not intended to limit the invention as further described in such appended claims. Therefore, the spirit and scope of the appended claims should not be limited to the exemplary description of the versions contained herein.

That which is claimed:

1. A barrier laminate, comprising:
(i) a nonwoven layer; and
(ii) a breathable microporous film layer attached to the nonwoven layer, wherein the breathable microporous film layer includes a plurality of pores having an average pore diameter from about 0.01 to about 0.5 microns.

2. The barrier laminate of claim 1, wherein about 90% to about 100% of the plurality of pores has an individual pore diameter from at most about 0.5 microns from the average pore diameter.

3. The barrier laminate of claim 1, wherein the plurality of pores has a pore-size-distribution comprising a standard deviation (SD) from about 0.01 microns to about 1 micron.

4. The barrier laminate of claim 1, wherein the breathable microporous film layer further comprises a plurality of filler particles.

5. The barrier laminate of claim 4, wherein the plurality of filler particles comprise an inorganic filler, an organic filler, a polymeric filler, or any combination thereof.

6. The barrier laminate of claim 1, wherein the nonwoven layer comprises a spunbond layer, a meltblown layer, a carded layer of staple fibers, or any combination thereof.

7. The barrier laminate of claim 1, wherein the nonwoven layer comprises a structure according to one of the following:
S1ₐ-M1_{b}-S2_{c}; and (Structure 1)
S1ₐ-M1_{b}-S3_{d}-M2_{c}-S2_{c}; (Structure 2)
wherein,
‘M1’ comprises a first meltblown layer or a first group of multiple meltblown layers;
‘M2’ comprises a second meltblown layer or a second group of multiple meltblown layers;
‘S1’ comprises a first spunbond layer or a first group of multiple spunbond layers;
‘S2’ comprises a second spunbond layer or a second group of multiple spunbond layers;
‘S3’ comprises a third spunbond layer or a third group of multiple spunbond layers;
‘a’ represents the number of layers and is independently selected from 0, 1, 2, 3, 4, 5, 6, 7, 8, 9, and 10;
‘b’ represents the number of layers and is independently selected from 0, 1, 2, 3, 4, 5, 6, 7, 8, 9, and 10;
‘c’ represents the number of layers and is independently selected from 0, 1, 2, 3, 4, 5, 6, 7, 8, 9, and 10;
‘d’ represents the number of layers and is independently selected from 0, 1, 2, 3, 4, 5, 6, 7, 8, 9, and 10; and
‘e’ represents the number of layers and is independently selected from 0, 1, 2, 3, 4, 5, 6, 7, 8, 9, and 10;
wherein for Structure 1 the sum of ‘a’, ‘b’, and ‘c’ is not zero; and
wherein for Structure 2 the sum of ‘a’, ‘b’, ‘c’, ‘d’, and ‘e’ is not zero.

8. The barrier laminate of claim 1, wherein the breathable microporous film layer comprises a synthetic polymeric material.

9. The barrier laminate of claim 1, wherein the breathable microporous film layer is thermally bonded to the nonwoven layer, adhesively bonded to the nonwoven layer, or extrusion coated onto the nonwoven layer.

10. The barrier laminate of claim 9, wherein the barrier laminate includes a pattern of thermal bond sites, wherein the breathable microporous film layer is thermally bonded to the nonwoven layer at the thermal bond sites, and the pattern of thermal bond sites define a bonded area from about 2% to about 40% of the barrier laminate.

11. The barrier laminate of claim 1, wherein the barrier laminate provides a Type 3 or Type 4 level of chemical protection per EN14605, a Type 5 level of chemical protection per EN13982-1, or a Type 6 level of chemical protection per EN13034.

12. The barrier laminate of claim 1, wherein the barrier laminate has a moisture vapor transmission rate (MVTR) of about 500 to about 3500 g/24 hrs/m².

13. A protective garment, comprising: a first barrier laminate comprising (i) a nonwoven layer; and (ii) a breathable microporous film layer attached to the nonwoven layer, wherein the breathable microporous film layer includes a plurality of pores having an average pore diameter from about 0.01 to about 0.5 microns.

14. The protective garment of claim 13, wherein the protective garment comprise a pair of coveralls, a jacket, sleeves, a jump-suit, a pair of pants, a foot covering, a boot covering, a glove, a hood, or an apron.

15. The protective garment of claim 13, wherein the protective garment provides a Type 3, Type 4, Type 5, or Type 6 level of chemical protection per EN 14605.

16. The protective garment of claim 15, further comprising a second barrier laminate that is bonded to the first barrier laminate.

17. A method of forming a protective garment, comprising:
(i) providing or forming a first barrier laminate component;
(ii) providing or forming a second barrier laminate component, wherein the first barrier laminate component is the same or different than the second barrier component; and
(iii) bonding a first portion of the first barrier laminate component to a second portion of the second barrier component;
wherein the first barrier laminate component, the second barrier laminate component or both comprise a nonwoven layer bonded to a breathable microporous film layer, wherein the breathable microporous film layer includes a plurality of pores having an average pore diameter from about 0.01 to about 0.5 microns.

18. The method of claim 17, wherein bonding the first portion of the first barrier laminate component to the second portion of the second barrier component comprises thermally bonding the first portion to the second portion to form a thermally bonded seam joining the first portion to the second portion.

19. The method of claim 17, wherein forming the first barrier laminate comprises thermally bonding or melt extruding a pre-microporous film precursor film including a plurality of filler particles to the nonwoven layer to form a precursor laminate, and forming the plurality of pores via incrementally stretching the precursor laminate to form the barrier laminate.

20. The method of claim 19, wherein the precursor laminate is incrementally stretched at a temperature from about 20° C. to about 50° C.,
